(19) United States
(12) Patent Application Publication
(10) Pub. No.: US 2026/0015466 A1
(43) Pub. Date: Jan. 15, 2026

(54) SILICONE COMPOSITION AS AN OCA-LIKE SILICONE OCR AND METHOD OF BONDING DISPLAY PANEL USING THE SAME

(71) Applicant: Wacker Chemicals AG, Munich (DE)

(72) Inventors: SeungA LEE, Seongnam-si (KR); GyeongHui LEE, Seongnam-si (KR); SeungHo HAN, Seongnam-si (KR)

(73) Assignee: Wacker Chemicals AG, Munich (DE)

(21) Appl. No.: 18/997,805

(22) PCT Filed: Aug. 5, 2022
(86) PCT No.: PCT/EP2022/072115

§ 371 Date: Jan. 23, 2025

(51) Int. Cl. C08G 77/00; C08K 5/56

(52) U.S. Cl. CPC C08G 77/70; C08K 5/56

(57) ABSTRACT

The present disclosure provides: a silicone composition including: (a1) a first organopolysiloxane including at least two unsaturated hydrocarbons; (a2) a second organopolysiloxane including at least one unit represented by SiO_{4/2}; (b) an organohydrogen siloxane including at least two SiH functional groups per molecule and at least one C₆ to C₂₀ aryl group per molecule; and (c) a catalyst for a hydrosilylation reaction, and a method of bonding display panels using the silicone composition.

### TECHNICAL FIELD

The present disclosure relates to a silicone composition, specifically, to a silicone composition for bonding (e.g., laminating) curved panels or multiple panels, and more specifically, to a photocurable high-tackiness silicone composition applicable to wet bonding and also gel bonding and solid bonding as an OCA-like Silicone OCR, and the present disclosure also relates to a method of bonding display panels using the silicone composition.

### BACKGROUND

A highly transparent silicone adhesive used for bonding front surfaces of a display panel and a cover induces bonding (e.g., laminating) in a liquid state, and thus it is applicable to various designs. Such a silicone adhesive is designed to overcome a height difference that may occur in the structure.

A silicone adhesive has a high stability as an interlayer adhesive material by virtue of its characteristics due to the flexible structure such as low shrinkage rate and stress relief function, as well as excellent properties of silicone itself, such as heat resistance and chemical resistance. The silicone adhesive is used as an adhesive material in the field of displays for automobiles due to such characteristics.

In the field of automobile displays, various types of designs have been recently sought after, and a multi-panel display type composed of several layers of panels becomes the main trend, and accordingly, there is a limit to the conventional wet bonding (e.g., liquid bonding). That is, the conventional high-transparent silicone liquid adhesive (e.g., OCR; Optically Clear Resin) has a problem in that it is difficult to adhere after solidification. In addition, the conventional film-type solid adhesive (e.g., OCA; Optical Clear Adhesive) has a problem in that it is difficult to address an issue of step difference caused by the structural characteristics.

Accordingly, there is a need for an adhesive capable of realizing both liquid and solid bonding in the process and solving the issue of step difference.

### OBJECTIVE OF INVENTION

Embodiments of the present disclosure are directed to a highly transparent photocurable silicone composition applicable to a curved design, capable of implementing wet bonding, gel bonding, and solid bonding in a process of bonding multiple panels concurrently, and exhibiting stable tackiness/adhesiveness by maintaining a strong surface tackiness even after solidification.

### TECHNICAL MEANS

Embodiments of the present disclosure provides: a silicone composition including: (a1) a first organopolysiloxane including at least two unsaturated hydrocarbons; (a2) a second organopolysiloxane including at least one unit represented by SiO_{4/2}; (b) an organohydrogen siloxane including at least two SiH functional groups per molecule and at least one C₆ to C₂₀ aryl group per molecule; and (c) a catalyst for a hydrosilylation reaction.

### EFFECTS OF THE INVENTION

According to one or more embodiments of the present disclosure, the silicone composition may be applicable to a curved design, and may implement both wet bonding and solid bonding, and thus multiple panels may be bonded concurrently. In addition, the silicone composition according to the present disclosure may maintain a strong surface tackiness even after solidification, thereby exhibiting stable tackiness/adhesiveness to be applicable to bonding of displays and electronic components of various designs.

The silicone composition according to the present disclosure may also be applicable to a plastic substrate, thus applicable to a variety of substrates, and it has excellent heat resistance and stress relieving properties, so it may be used for outdoor or automobile display devices exposed to severe conditions.

The silicone composition according to the present disclosure has advantages in that it exhibits rapid curing behavior and adhesion formation speed, particularly at low temperatures, thus applicable to the field where dimensional stability of a module is important in the process, such as curved displays.

In addition, the silicone composition of the present disclosure may adjust a viscosity to be applicable to various dispensing methods, and thus, it is not significantly restricted to the dispensing method, and may be applicable without being greatly affected by the shape or application area of substrates.

### DETAILED DESCRIPTION OF THE INVENTION

An embodiment of the present disclosure provides a silicon composition including: (a1) a first organopolysiloxane including at least two unsaturated hydrocarbons; (a2) a second organopolysiloxane including at least one unit represented by SiO_{4/2}; (b) an organohydrogen siloxane including at least two SiH functional groups per molecule and at least one C₆ to C₂₀ aryl group per molecule; and (c) a catalyst for hydrosilylation reaction.

Hereinafter, each component will be described in detail.

### 1. Component (a)

Component (a) is an organopolysiloxane. The silicone composition according to an embodiment of the present disclosure includes, as the component (a), two or more organopolysiloxanes including (a1) a first organopolysiloxane including at least two unsaturated hydrocarbons; and (a2) a second organopolysiloxane including at least one unit represented by SiO_{4/2}.

The first organopolysiloxane (a1) and the second organopolysiloxane (a2) may each independently have a linear structure, a branched chain structure, a cyclic structure, or a linear structure having a partially branched or partially cyclic structure.

The first organopolysiloxane (a1) and the second organopolysiloxane (a2) may each independently include a C₂ to C₂₀ alkenyl group, and preferably a C₂ to C₁₂ alkenyl group such as a vinyl group, a propenyl group, an isopropenyl group, a butenyl group, a hexenyl group, and an octenyl group.

It is preferable that the unsaturated hydrocarbon of the first organopolysiloxane (a1) is an alkenyl group.

In addition, it is preferable that the second organopolysiloxane (a2) includes an unsaturated hydrocarbon.

It is preferable that the first organopolysiloxane (a1) and/or the second organopolysiloxane (a2) includes a C₂ to C₂₀ alkenyl group bonded to at least one Si at both ends or a chain.

The first and second organopolysiloxanes both contain an organyl group bonded to a silicon atom, in addition to the alkenyl group bonded to the silicon (Si) atom. As used herein, the organyl group is a monovalent hydrocarbon group having 1 to 20 carbon atoms, specifically 1 to 10 carbon atoms, and more specifically 1 to 8 carbon atoms, and may be substituted or unsubstituted. For example, the organyl group may be a C₁ to C₂₀ alkyl group such as a methyl group, an ethyl group, a propyl group, an isopropyl group, a butyl group, an isobutyl group, a tert-butyl group, a pentyl group, a neopentyl group, a hexyl group, an octyl group, a nonyl group, and a decyl group; a C₆ to C₂₀ aryl group such as a phenyl group, a tolyl group, a xylyl group, and a naphthyl group; and a C₇ to C₂₀ aralkyl group such as a phenylethyl group and a phenylpropyl group.

It is preferable that the first organopolysiloxane (a1) and/or the second organopolysiloxane (a2) include at least one unit selected from among R₃SiO_{1/2}, R₂SiO_{2/2}, RSiO_{3/2}, and SiO_{4/2}.

It is preferable that the first organopolysiloxane (a1) and the second organopolysiloxane (a2) each have a weight average molecular weight in a range of 1,000 to 200,000 g/mol, and more preferably in a range of 10,000 to 50,000 g/mol. It is also preferred to have a viscosity in a range of about 100 to 600,000 mPa·s at 25° C.

In the silicone composition of the present disclosure, a sum of contents of the first and second organopolysiloxanes is preferably in a range of 10 to 90 percent by weight (wt %), and more preferably in a range of 50 to 80 wt %, with respect to the total amount of the silicone composition.

### 2. Component (b)

Component (b) is an organohydrogen siloxane including at least two SiH functional groups per molecule and at least one C₆ to C₂₀ aryl group per molecule, and is a type of crosslinking agent that reacts with the alkenyl group of the component (a) to form a matrix of polymers with a network structure.

It is preferable that the component (b) includes hydrogen bonded to a silicon atom in a side chain of the polymer chain (e.g., Si—H group). It is also preferred that the organohydrogen siloxane of the component (b) includes Si—H functional groups at both ends.

It is preferable that the component (b) includes at least one phenyl group per molecule.

The component (b) may have an organosiloxane structure formed from units represented by general formulas of R₃SiO_{1/2}, R₂SiO_{2/2}, RSiO_{3/2}, and SiO_{4/2}, having a linear structure, a branched chain structure, a cyclic structure, or a linear structure having a partially branched or partially cyclic structure.

Specifically, the component (b) may include a C₁ to C₂₀ monovalent hydrocarbon group as the organyl group, and more specifically, may include a hydrocarbon group selected from: a C₁ to C₂₀ alkyl group and a C₇ to C₂₀ aralkyl group.

In the silicone composition of the present disclosure, in the case of an organohydrogen siloxane formed from units represented by SiO_{4/2}, in order to secure a modulus in a range of 10³ to 10⁴ Pa after full curing (e.g., complete curing), it is preferable that a content of the organohydrogen siloxane of the component (b) is in a range of about 1 to 50 wt %, and more preferably in a range of about 10 to 20 wt %, with respect to the total amount of the silicone composition.

In the silicone composition of the present disclosure, for rapid curing at low-temperature after UV irradiation, it is preferable that a content of the organohydrogen siloxane of the component (b) is such that hydrogen atoms bonded with silicon in the component (b) is 0.5 mol or more, and more preferably in a range of 0.6 to 0.9 mol, per 1 mol of the alkenyl group of the components (a1) and (a2).

In the silicone composition of the present disclosure, in order to maintain a damping factor of 0.5 or more and a modulus of 10³ to 10⁴ Pa after full curing, in the case of an organosiloxane that may form a long molecular length by having SiH at both ends, it is preferable that a content of the organohydrogen siloxane of the component (b) is such that hydrogen atoms bonded with silicon in the component (b) is 0.3 mol or more, and more preferably in a range of 0.5 to 0.8 mol, with respect to 1 mol of the alkenyl group of the components (a1) and (a2).

### 3. Component (c)

Component (c) is a catalyst for a hydrosilylation reaction. The catalyst is a component for promoting a reaction between the aforementioned organopolysiloxane (a) and organohydrogen siloxane (b). It is preferable that the catalyst is a metallic catalyst oxidizable by UV, and the catalyst applicable in the present disclosure is not particularly limited as long as it is used in the hydrosilylation reaction in the art, such as a platinum-based catalyst, a palladium-based catalyst, or a rhodium-based catalyst, among which platinum or a platinum compound having excellent reactivity is preferable. For example, there are platinum clusters, platinum black, platinum chloride, chloroplatinic acid and its salts, alcohol-modified chloroplatinic acid, chloroplatinic acid-olefin complex, platinum coordination compound, and the like, which are each supported in a carrier such as silica or carbon.

In the silicone composition of the present disclosure, a content of the catalyst of the component (c) is not particularly limited, but if the content of the catalyst is too low, effect as the catalyst may not be achieved, and on the other hand, if the content of the catalyst is too high, optical stability after full curing may be degraded, thus being uneconomical. In addition, since a catalyst content affects curing behavior, in order to achieve low-temperature rapid curing, it is preferable that a content of the catalyst of the component (c) is adjusted to a range of about 10 to 100 ppm, and specifically in a range of about 15 to 30 ppm, in terms of a metal content.

### 4. Others

In addition to the components (a) to (c) described above, the silicone composition according to the present disclosure may further optionally include additives commonly known in the art according to the purpose and environment of use of the composition. Examples thereof may include, but are not limited to, adhesion agents, coupling agents, dyes, pigments, flame retardants, thickeners, leveling agents, thixotropic agents, and the like.

A content of the additives is not particularly limited and may be used within a conventional range known in the art. For example, it may be in a range of about 0.001 to 10 wt %, specifically in a range of about 0.01 to 5 wt %, and more specifically, in a range of about 0.1 to 3 wt %, with respect to the total amount of the silicone composition.

It is preferable that a viscosity of the silicone composition according to the present disclosure is in a range of 100 to 100,000 mPa·s at 25° C. with respect to a kinematic viscosity in a range of 10 to 25 rpm so as to be applicable to various dispensing equipment. Specifically, it is more preferable that the viscosity is in a range of 100 to 5,000 mPa·s for nozzle dispensing, in a range of 5,000 to 20,000 mPa·s for slit coating, in a range of 5,000 to 20,000 mPa·s for screen printing, and in a range of 20,000 to 100,000 mPa·s for stencil printing.

It is preferable that the silicone composition according to the present disclosure has a damping factor of 0.5 or more after full curing. In addition, it is preferable to have a modulus in a range of 10³ to 10⁴ Pa.

The silicone composition according to the present disclosure preferably has a surface tackiness of at least 20 g·sec or more under a condition of a 5 mm cylindrical stainless probe, 100 g load, 5 sec contact time, and 0.5 mm/s test speed after full curing, and preferably has a tackiness of at least 100 gf/cm or more with respect to 180° peel strength (Glass/PET) even in the case of bonding after full curing.

In addition, for effective leveling after application, it is preferable that a thixotropy index becomes closer to 1, with respect to a similar dynamic viscosity in a range of 0.1 to 25 rpm.

The UV curing conditions of the silicone composition of the present disclosure are not particularly limited, but should be adjusted according to a time period from UV irradiation to bonding in a corresponding process. For example, for wet bonding, it may be in a range of 1,000 to 5,000 mJ/cm² with respect to a 365 nm LED lamp, and a post-curing process by heat may be added for gel bonding or solid bonding. The post-curing process by heat is not particularly limited, and it may be, for example, a heat block, infrared (IR) irradiation, a heat chamber, and a heat curtain.

The silicone composition according to the present disclosure may be applicable to all of bonding immediately after UV irradiation, bonding after gelation, and bonding after full curing. That is, by using the silicone composition according to the present disclosure, wet bonding and solid bonding may be concurrently performed to bond multiple display panels at a time. The silicone composition according to the present disclosure may be used for bonding, sealing, or assembly in display devices, electronic components, solar cell modules, semiconductors, or automotive components. In the case of a display device, for example, it may be used as a housing or a backlight unit in liquid crystal displays (LCD), light emitting diode (LED) displays, or organic electroluminescent (EL) displays.

Hereinafter, the present disclosure will be described in detail through embodiments. However, the following embodiments are only illustrative of the present disclosure, and the present disclosure is not limited by the following embodiments.

### EMBODIMENTS 1 to 9, COMPARATIVE EXAMPLES 1 to 3

Respective components described below were uniformly vacuum-mixed at composition ratios (parts by mass) as shown in Table 1 to prepare photocurable, high-tackiness, rapid-curing silicone compositions of Embodiments (Embod.) and Comparative Examples (Comp. Ex.), respectively. In each structural formula, Me is a methyl group and Vi is a vinyl group.

TABLE 1

| | | | | | | | Comp. | Comp. | Comp. |
|---|---|---|---|---|---|---|---|---|---|
| | | Embod. 1 | Embod. 2 | Embod. 3 | Embod. 4 | Embod. 5 | Ex. 1 | Ex. 2 | Ex. 3 |
| Composition | a-1 | 68.39% | 0.00% | 0.00% | 0.00% | 0.00% | 97.87% | 0.00% | 0.00% |
| | a-2 | 0.00% | 0.00% | 73.01% | 32.92% | 0.00% | 0.00% | 98.01% | 14.12% |
| | a-3 | 0.00% | 16.10% | 0.00% | 51.59% | 85.18% | 0.00% | 0.00% | 84.00% |
| | a-4 | 11.00% | 34.22% | 11.34% | 0.00% | 0.00% | 0.00% | 0.00% | 0.00% |
| | a-5 | 0.00% | 0.00% | 0.00% | 12.31% | 11.85% | 0.00% | 0.00% | 0.00% |
| | b-1 | 19.61% | 0.00% | 13.23% | 0.00% | 0.00% | 0.00% | 0.00% | 0.00% |
| | b-2 | 0.00% | 48.68% | 0.00% | 0.00% | 0.00% | 0.00% | 0.00% | 0.00% |
| | b-3 | 0.00% | 0.00% | 0.00% | 0.00% | 0.18% | 1.23% | 1.09% | 0.98% |
| | b-4 | 0.10% | 0.10% | 0.00% | 0.13% | 0.00% | 0.00% | 0.00% | 0.00% |
| | b-5 | 0.00% | 0.00% | 1.52% | 2.15% | 1.89% | 0.00% | 0.00% | 0.00% |
| | c-1 | 0.90% | 0.90% | 0.90% | 0.90% | 0.90% | 0.90% | 0.90% | 0.90% |
| | Total | 100.00% | 100.00% | 100.00% | 100.00% | 100.00% | 100.00% | 100.00% | 100.00% |
| | components | | | | | | | | |

The following components were used for the component (a).

$$a - 1 : ( {CH}_{2} = {CHMe}_{2} SiO ( {SiMe}_{2} O ) \times {SiMe}_{2} CH = {CH}_{2} ) , M w = 7800 g / mol , Average chain length = 110$$

$$a - 2 : ( {CH}_{2} = {CHMe}_{2} SiO ( {SiMe}_{2} O ) \times {SiMe}_{2} CH = {CH}_{2} ) , M w = 36800 g / mol , Average chain length = 441$$

$$a - 3 : ( {CH}_{2} = {CHMe}_{2} SiO ( {SiMe}_{2} O ) \times {SiMe}_{2} CH = {CH}_{2} ) , M w = 76500 g / mol , Average chain length = 1040$$

$$a - 4 : {M}_{5} {M}_{1}^{V i} {Q}_{4}$$

$$a - 5 : {M}_{7} {M}_{1}^{V i} {Q}_{12}$$

The following components were used for the component (b).

$$b - 1 : H - ( {SiMe}_{2} O ) \times {SiMe}_{2} - H , Mw = 5 , 000 g / mol$$

$$b - 2 : H - ( {SiMe}_{2} O ) \times {SiMe}_{2} - H , Mw = 16 , 400 g / mol$$

$$b - 3 : {Me}_{3} SiO ( {Me}_{2} SiO ) \times ( MeHSiO ) {y SiMe}_{3} , M w = 5 , 000 g / mol$$

$$b - 4 : M - {D}^{P {h}_{40}} - D {H}_{20} - M$$

$$b - 5 : H - {M}_{2} - {D}^{P {h}_{2}} - {M}_{2} - H$$

The following component was used for the component (c).

$$c - 1 : Methylcyclopentadienyl - trimethyl - platinum ( IV )$$

### EXPERIMENTAL EXAMPLE

Viscosity, modulus, surface tackiness, peel strength, and the like were measured for the compositions of Embodiments 1 to 5 and Comparative Examples 1 to 3, and the results are shown in Table 2 below.

TABLE 2

| | | | | | | | Comp. | Comp. | Comp. |
|---|---|---|---|---|---|---|---|---|---|
| | | Embod. 1 | Embod. 2 | Embod. 3 | Embod. 4 | Embod. 5 | Ex. 1 | Ex. 2 | Ex. 3 |
| Eval. | Viscosity | 1350 | 1420 | 7500 | 38000 | 47200 | 1150 | 6880 | 46000 |
| result | (mPa · s) | | | | | | | | |
| | Hardness | 65 | 72 | 52 | 43 | 32 | 18 | 22 | 21 |
| | (penetration, | | | | | | | | |
| | 1/10 mm) | | | | | | | | |
| | (1) Wet | 685 | 780 | 770 | 832 | 850 | 110 | 185 | 250 |
| | bonding + 180° | | | | | | | | |
| | Peel(gf/cm) | | | | | | | | |
| | (Fracture | Cohesive | Cohesive | Cohesive | Cohesive | Cohesive | Cohesive | Cohesive | Cohesive |
| | mode) | | | | | | | | |
| | Modulus (G′, | 3250 | 2832 | 2510 | 4320 | 5330 | 36420 | 34700 | 28950 |
| | Pa) | | | | | | | | |
| | Damping factor | 0.51 | 0.65 | 0.89 | 0.54 | 0.36 | 0.03 | 0.03 | 0.04 |
| | (δ) | | | | | | | | |
| | Surface | 26 | 32 | 45 | 23 | 19 | 6 | 6 | 8 |
| | tackiness | | | | | | | | |
| | (Tackiness, | | | | | | | | |
| | g · sec) | | | | | | | | |
| | (2) Gel | 682 | 685 | 745 | 436 | 285 | 53 | 65 | 72 |
| | bonding + 180° | | | | | | | | |
| | Peel(gf/cm) | | | | | | | | |
| | (Fracture | Cohesive | Cohesive | Cohesive | Cohesive | Cohesive | Adhesive | Adhesive | Adhesive |
| | mode) | | | | | | | | |
| | (3) Bonding | 432 | 501 | 585 | 286 | 115 | <10 | <10 | <10 |
| | after full | | | | | | | | |
| | curing + 180° | | | | | | | | |
| | Peel(gf/cm) | | | | | | | | |
| | (Fracture | Cohesive | Cohesive | Cohesive | Adhesive | Adhesive | Adhesive | Adhesive | Adhesive |
| | mode) | | | | | | | | |

The viscosity was measured using a rheometer (Anton Paar, CP50-2, 25/shear rate), and the hardness was measured using a penetration, 9.38 g cone.

The 180° peel strength was measured by coating the silicone composition to a thickness of 0.3 mm on a glass substrate (width 50 mm×length 100 mm×thickness 5 mm) to be irradiated with a 2500 mW/cm² 365 nm LED lamp at 3,000 mJ/cm².

In the case of (1), a PET film was bonded within 1 minute, in the case of (2), a PET film was bonded after confirming a gel state at a point in time in a range of 3 to 5 minutes, and in the case of (3), it was left at room temperature for a day to be fully cured, and then a PET film was bonded.

The specimens were displaced in a 180° direction where the PET film was peeled off at a rate of 300 mm/min according to ASTM D 3330, and the 180° peel strength (gf/cm) of the silicone composition was measured from an obtained maximum stress. In such a case, if a fracture mode (e.g., failure mode) remained on both substrates, it was determined as ‘cohesive’, and if it remained on only one substrate, it was determined as ‘adhesive’.

The modulus was measured using a rheometer (Anton Paar, PP12.5, 1 Hz) under shear stress after full curing.

The damping factor is a value obtained by dividing a loss modulus (G″) by a storage modulus (G′) obtained in the modulus measurement.

The surface tackiness was estimated by measuring a tackiness, which was evaluated with respect to conditions of a 5 mm cylindrical stainless probe, 100 g load, 5 sec contact time, and 0.5 mm/s test speed.

In the case of Embodiments 1 to 3, all the compositions were cured (there was no uncured portion), and showed a cohesive fracture mode overall, indicating that these compositions may be used not only for wet bonding, but also for gel bonding and solid bonding. In the case of Embodiments 4 and 5, an adhesive mode was observed under the condition of bonding after full curing, and accordingly, it was appreciated that they were applicable only to the gel bonding.

In the case of Comparative Examples 1 to 3, the compositions which lack part of the components (a) and (b) all exhibited an adhesive fracture mode in gel bonding and in bonding after full curing, so it was appreciated that they were not applicable to gel bonding and solid bonding.

1-20. (canceled)

21. A silicone composition comprising:
(a1) a first organopolysiloxane comprising at least two unsaturated hydrocarbons, and units represented by R₃SiO_{1/2} and R₂SiO_{2/2};
(a2) a second organopolysiloxane comprising at least one unit represented by SiO_{4/2}, and comprising unsaturated hydrocarbons;
(b) an organohydrogen siloxane comprising at least two SiH functional groups per molecule and at least one C₆ to C₂₀ aryl group per molecule, and units represented by R₃SiO_{1/2} and R₂SiO_{2/2}; and
(c) a catalyst for a hydrosilylation reaction.

22. The silicone composition of claim 21, wherein the unsaturated hydrocarbon of the component (a1) is an alkenyl group.

23. The silicone composition of claim 21, wherein the component (a1) and/or the component (a2) comprises a C₂ to C₂₀ alkenyl group bonded to t least one Si at both ends or a chain.

24. The silicone composition of claim 21, wherein the component (a1) and/or the component (a2) has a weight average molecular weight in a range of 1,000 to 200,000 g/mol.

25. The silicone composition of claim 21, wherein the component (b) comprises at least one phenyl group per molecule.

26. The silicone composition of claim 21, wherein hydrogen atoms bonded to silicon of the component (b) is 0.3 mol or more with respect to 1 mol of an alkenyl group of the component (a1) and/or the component (a2).

27. The silicone composition of claim 21, wherein the organohydrogen siloxane of the component (b) comprises Si—H functional groups at both ends.

28. The silicone composition of claim 21, wherein the component (c) is a metallic catalyst oxidizable by UV.

29. The silicone composition of claim 21, wherein the component (c) comprises 10 to 100 ppm of a metal with respect to the total weight of the silicone composition.

30. The silicone composition of claim 21, having a surface tackiness of at least 20 g·sec or more under a condition of a 5 mm cylindrical stainless probe, 100 g load, 5 sec contact time, and 0.5 mm/s test speed after full curing.

31. The silicone composition of claim 21, applicable to all of wet bonding and also gel bonding, and solid bonding as an OCA-like Silicone OCR.

32. The silicone composition of claim 21, applicable to bonding, sealing, or assembly in display devices, electronic components, solar cell modules, semiconductors, or automotive components.

33. The silicone composition of claim 21 for bonding curved panels or multiple panels.

34. A method of concurrently bonding display panels, the method comprising:
concurrently performing wet bonding, gel bonding and solid bonding using the silicone composition of claim 21.
